(19) United States
(12) Patent Application Publication
(10) Pub. No.: US 2015/0114771 A1
(43) Pub. Date: Apr. 30, 2015

(54) BRAKE SYSTEM AND BRAKING METHOD FOR AN ELECTRICALLY ACTUATED NONLINEAR FRICTION BRAKE

(71) Applicant: VE VIENNA ENGINEERING FORSCHUNGS-UND ENTWICKLUNGS GMBH, Wien (AT)

(72) Inventor: Michael Putz, Gross Enzersdorf (AT)

(73) Assignee: VE VIENNA ENGINEERING FORSCHUNGS-UND ENTWICKLUNGS GMBH, Wien (AT)

(21) Appl. No.: 14/391,866

(22) PCT Filed: Apr. 5, 2013
(86) PCT No.: PCT/EP2013/057192

§ 371 Date: Oct. 10, 2014

(30) Foreign Application Priority Data
Apr. 12, 2012 (AT) A50129/2012

(51) Int. Cl. F16D 65/38; B60T 7/04

(52) U.S. Cl. CPC F16D 65/38; B60T 7/042; F16D 2065/386
USPC 188/158

(57) ABSTRACT

In an electrically actuated friction brake (1) with non-linear force-travel characteristic, in which, in order to brake, an actuating part of a pressing device (10) is rotated by means of an actuating device (20) between an initial actuating angle (α_{A}) and a final actuating angle (α_{E}) in order to press a brake lining (6) against a friction surface to produce a braking torque (T_{B}), the effect of the brake lining elasticity, which varies with wear, cannot be ignored. The force-travel characteristic of the friction brake (1) which changes as a result is compensated for in that the initial actuating angle (α_{A}) of the actuating part of the friction brake (1) is adjusted as a function of the current state of wear of the brake lining (6).

The present invention relates to a braking system and a method for operating an electrically actuated, non-linear friction brake, wherein, in order to brake, an actuating part of a pressing device is rotated by means of an actuating device between an initial actuating angle and a final actuating angle in order to press a brake lining against a friction surface to produce a braking torque, wherein the pressing device is arranged on a wear adjuster.

As well as conventional hydraulic and pneumatic brakes, braking systems actuated by other means which, for example, press a friction lining against a friction surface of the friction brake by means of an electric motor, such as for example screw drives (e.g. for parking brakes and also, on a trial basis, for service brakes) or so-called wedge brakes, such as are described in DE 103 92 252 B4, for example, are also known today. This describes an electromagnetic friction brake with self-reinforcement, in which rollers roll on wedge-shaped rotatable ramps in order to apply the brake lining. An electromagnetic friction brake with self-reinforcement, in which an engagement angle of a lever on which a brake lining is arranged can be adjusted in order to vary the magnitude of the self-reinforcement, is also described in DE 103 24 424 A1.

In turn, a brake actuated by means of an eccentric can be found in WO 2010/133463 A1. Friction brakes, which are applied by means of cams, eccentrics, toggle-levers or similar, as in WO 2010/133463 A1 for example, fundamentally have a non-linear force-travel characteristic, that is to say that the pressure force (or the pressure torque) produced does not have a linear relationship with the actuating travel (or angle of rotation). For this reason, these friction brakes are also usually actuated by means of electronic controllers.

The mechanical work (energy) required to clamp a friction brake according to WO 2010/133463 A1 is Force*Distance, e.g., for the front wheel brake of a medium-sized vehicle 30 kN*1 mm=30 J (if a realistic 30 kN application force of the brake lining is assumed for a distance of 1 mm covered during the clamping operation). Here, the energy of 30 J occurs with full braking; at the commencement of braking, the energy introduced is zero. A surprisingly small amount of mechanical energy is required for clamping a front brake for full braking. If this is to take place in, for example, 0.2 s (typical time for full braking of a friction brake), the mechanical power consumption during this time is 150 W depending on the speed characteristic. However, in the case of an electrically actuated brake, the electrical requirement per front-wheel brake is easily 300 W due to the efficiency of the electric motor, actuating mechanism and control electronics. Here, the actuating mechanism of the brake is also subjected to high forces (e.g. 30 kN), as a result of which additional mechanical friction occurs in the moving parts of the friction brake, even with good bearings. Therefore, depending on the mounting of the actuating mechanism, up to 600 W electrical actuating power per front wheel at full braking is not to be ruled out. These powers (up to 1.2 kW for both front brakes) approach the limit of a 12 V on-board power supply of a conventional motor vehicle, particularly when, in addition, other electrical loads, such as for example lights, air conditioning, heating, vehicle entertainment systems etc., are switched on. It is therefore desirable to have to apply as little electrical energy or power as possible for a braking operation, which is particularly relevant for hybrid or electric vehicles. However, there are two obvious ways in which to improve the energy or power for clamping the friction brake: on the one hand, the required pressure force can be reduced by lower friction in the actuation and/or supporting self-reinforcement in the friction brake; on the other, the actuating distance can be reduced by stiffer brakes (which deform to a lesser extent when clamping). At the same time, self-reinforcement is an effect which has long been known in friction brakes, and comes about in that, during a braking operation, the friction lining is displaced by the friction between the friction lining and the friction surface and thereby reinforces the braking effect. This effect is deliberately utilized in many friction brakes.

With the brake according to WO 2010/133463 A1, the stiffness of the brake caliper is relatively high due to the method of construction, as the brake caliper is designed in the form of a box which is open on one side in order to accommodate the actuating mechanism in the interior of the box-shaped brake caliper. This open box naturally has a good resistance to bending during clamping due to the three-dimensional structure with high walls. The low deformations which can be achieved can therefore be used to reduce the actuating travel and therefore proportionately to reducing the actuating energy and power. The box-shaped brake caliper described can therefore be designed for deformations of approximately 0.2 to 1 mm, that is to say relatively stiff, depending on load, material and geometry (by way of comparison, brake calipers for hydraulic brakes can open by well over 1 mm without any problems during full braking, that is to say they are relatively soft, as the braking energy comes from the brake servo and does not have to be generated by the on-board power supply). This enables the electrical actuating energy to be approximately halved compared with the above calculation, and actuation from the 12 V on-board power supply is again possible without problems.

However, there are other problems with an electrically actuated brake where the aim is for high stiffness. With conventional brakes with low stiffness, the elasticity of the brake caliper dominates compared with the lining elasticity. However, the lining elasticity changes quite considerably over the life of the lining from fresh to worn. In the worn state, the lining elasticity tends to zero, as almost only the steel mounting plates of the friction linings are still present. When the elasticity of the brake caliper is high (the stiffness is therefore low), the overall behavior of the friction brake will only change slightly however, as the changing lining elasticity is of little consequence. This is the case with conventional brakes; with conventional brakes, it was therefore previously unnecessary to take measures for changes in braking due to lining wear. If, however, a brake with high stiffness is required, as in the case of an electrically actuated brake, then a significant part of the overall elastic behavior of the friction brake results from the brake linings. With the highly varying lining elasticity as the lining wears however, the behavior of the friction brake also changes significantly as a result thereof, as the force-travel characteristic of the friction brake changes. In the case of stiffer brakes, the effect of the stiffness of the brake or of the brake parts on the force-travel characteristic of the friction brake is therefore large; with softer brakes it is rather small but basically occurs in all cases.

DE 10 2004 008 383 A1 describes a method for keeping the transmission behavior of a brake constant during a braking operation. During a braking operation, the operating temperature of the brake, which affects the coefficient of friction, the contact position and the stiffness of the brake, increases. The disclosed method is intended to control this effect as a function of travel during a braking operation. A way of compensating for the changing elastic behavior as the brake linings wear cannot be derived from DE 10 2004 008 383 A1.

It is therefore an object of the present invention to reduce the effect of the changing elastic behavior as the brake linings wear in an electrically actuated friction brake with non-linear travel-force characteristic.

According to the invention, this object is achieved in that the initial actuating angle of the actuating part is adjusted as a function of a current state of wear of the brake lining.

Friction brakes with non-linear travel-force characteristic are not actuated directly like hydraulic brakes but indirectly via electronic brake controllers. In this case, the brake pedal is not connected directly to the brake lining. However, the “pedal feel” is very important for good modulation and operability of a brake. As a rule, the actuating force on the brake pedal must also increase with increasing braking effect, possibly even greatly against full braking. Here, the brake controller ensures that a comfortable relationship is produced between the force-travel characteristic at the brake pedal and the force-travel characteristic of the brake. However, the “pedal feel” would also change this advantageously as the force-travel characteristic of the brake changes, e.g. due to the changing elasticity the brake as the brake lining wears.

It is therefore a further object of the invention to reduce the effect of the changing elastic behavior on the pedal feel as the brake linings wear, which is achieved in that the brake pedal feel is adjusted as a function of the current state of wear of the brake lining.

At the same time, the present invention is particularly advantageous when, in the case of a “stiff” friction brake, the change in the braking behavior due to wear of the elastic brake lining is so great that the operating behavior of the friction brake, in particular electrical energy to be applied and/or brake pedal feel, do not change to a negligible extent. This problem is eliminated or at least reduced by the measures according to the invention in that the changing force-travel characteristic of the friction brake is compensated for. This compensation can consist of two aspects, namely the force-travel characteristic which the driver senses at the brake pedal, and the adjustment of favorable internal operating states in the friction brake or in the actuating mechanism.

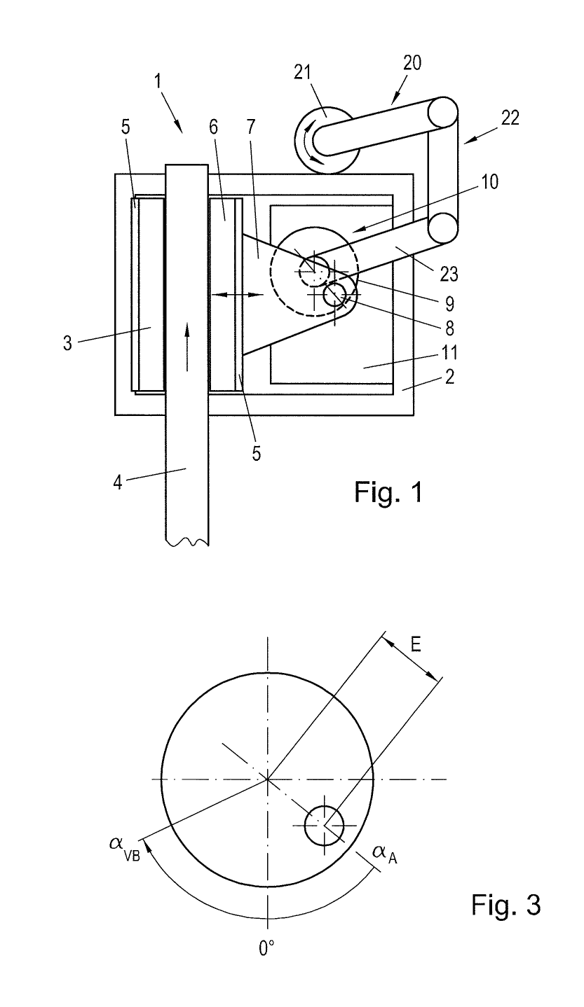

The present invention is explained in more detail below with reference to FIGS. 1 to 6, which show advantageous embodiments of the invention in an exemplary, schematic and non-restricting form. In the drawing

FIG. 1 shows a schematic diagram of a floating caliper disk brake with brake actuator,

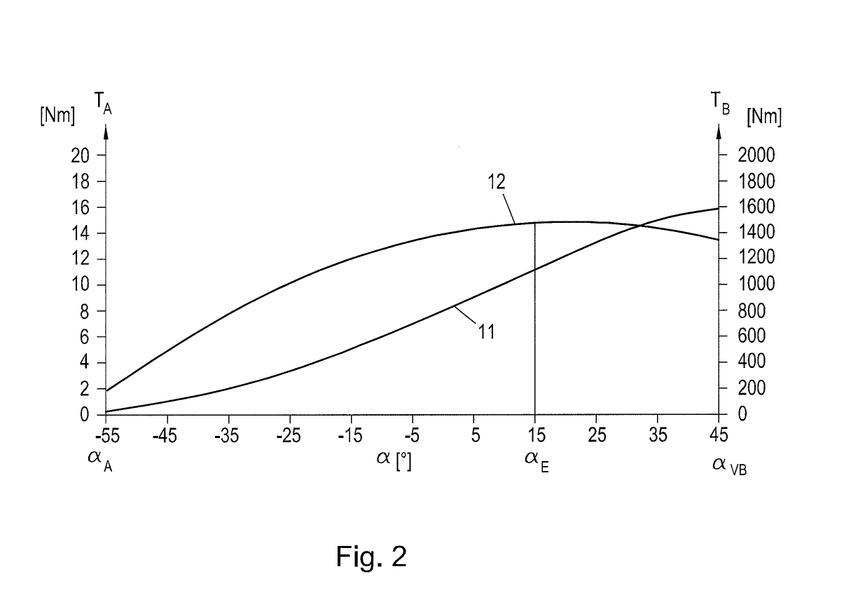

FIG. 2 shows the characteristic of the actuating torque T_{A} and the braking torque T_{B} as a function of the actuating angle α,

FIG. 3 shows the actuating angle range using an eccentrically actuated friction brake as an example,

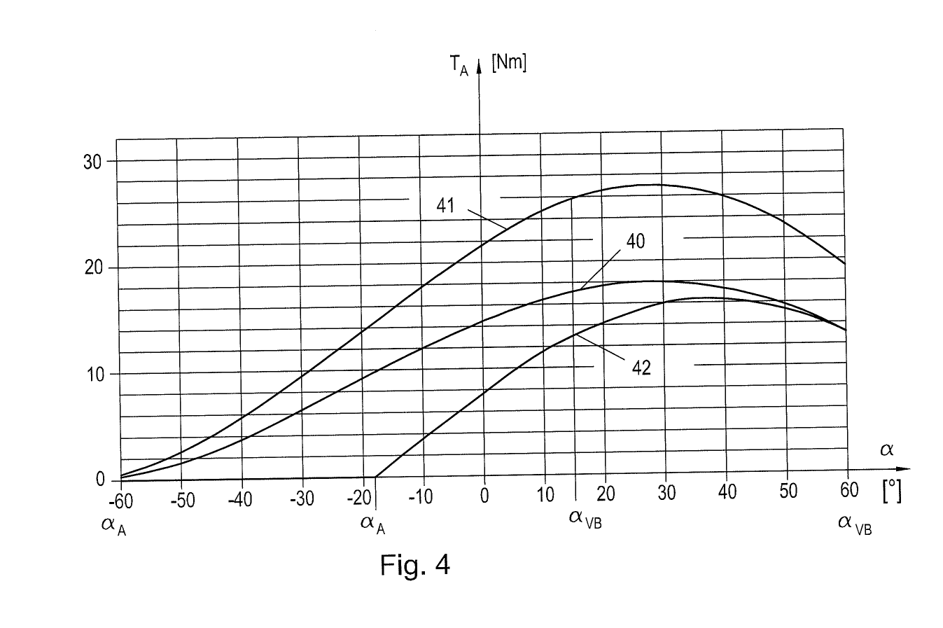

FIG. 4 shows the characteristic of the actuating torque T_{A} as a function of the actuating angle α for new and worn brake linings,

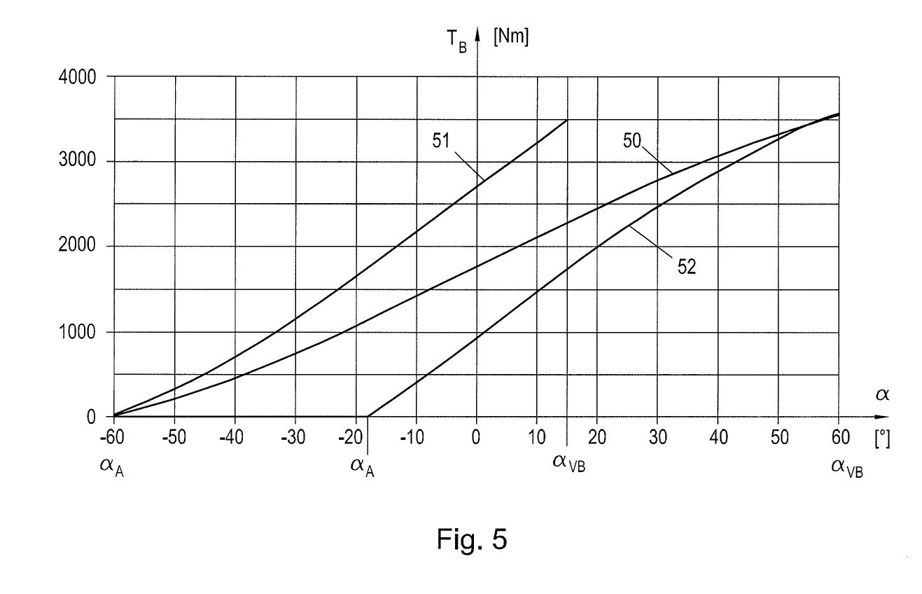

FIG. 5 shows the characteristic of the braking torque T_{B} as a function of the actuating angle α for new and worn brake linings, and

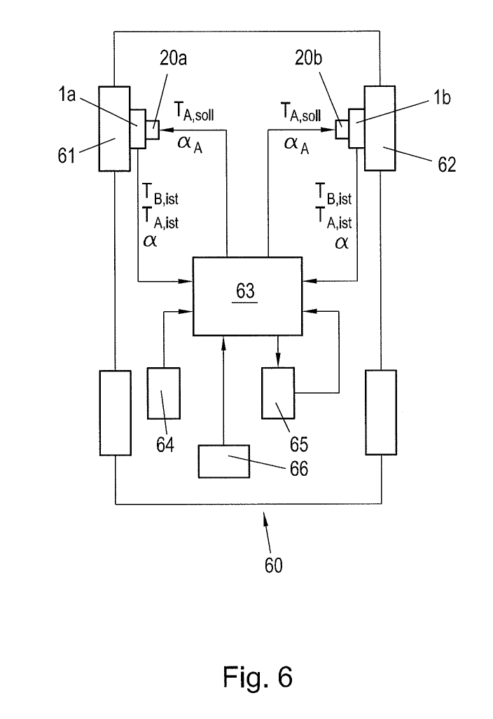

FIG. 6 shows a braking system in a vehicle.

The invention is explained in more detail below by way of example with reference to FIG. 1 with reference to a schematically shown friction brake 1 in the form of a floating caliper disk brake. Floating caliper disk brakes per se have long been known, for which reason the properties and function of a floating caliper disk brake and the basic installation of a floating caliper disk brake, e.g. in a vehicle, will not be discussed here. However, the invention can also be applied to other types of brake, e.g. a drum brake. In the same way, friction surfaces other than a brake disk or brake drum can also be provided, e.g. a more or less flat surface, e.g. as a brake for a linear movement.

FIG. 1 shows a friction brake 1 with a floating caliper 2 as the brake caliper which encompasses a friction surface, here in the form of a brake disk 4. A fixed (referred to the floating caliper 2) brake lining 3 and a moving (likewise referred to the brake caliper 2) brake lining 6 are arranged on the floating caliper 2. In order to brake, after overcoming any air gap which may be present, the moving brake lining 6 is pressed against the brake disk 4 by means of a pressing device 10 as shown by the double arrow in FIG. 1. In doing so, the floating caliper 2 automatically centers itself so that both brake linings 3, 6 rest on the brake disk 4 and are pressed against it. This results in the lining pressing force which gives rise to a certain braking torque. At the same time, the brake lining 3, 6 can in each case also be arranged on a lining carrier 5.

The pressing device 10 is arranged on a brake part. The brake part can be the floating caliper 2 but, as here, can also be a wear adjuster 11, which is known per se. Here, the wear adjuster 11 is arranged on the floating caliper 2, and the pressing device 10 in turn on the wear adjuster 11. At the same time, the entire pressing device 10 is moved by the wear adjuster 11 in order to compensate for wear that has occurred on the brake linings 3, 6. Here, the pressing device 10 or the brake lining 3 can preferably be guided in the friction brake 1, e.g., as here, in the floating caliper 2. As the wear adjuster 11 only has to move very small distances, and that only from time to time, the pressing device 10 is arranged in an effectively fixed manner in the friction brake 1. Such a wear adjuster 11 is known per se in many designs, for which reason it will not be discussed in more detail here. The wear adjuster 11 can be used either for compensation in the case of excessive air gap between brake lining 3, 6 and brake disk 4 only (in a similar way to drum brakes), or it can also be used shortly before every brake actuation to bring the air gap (also both) between brake lining 3, 6 and brake disk 4 to zero and even to introduce an initial small pressure force in the friction brake 1.

When operating the friction brake 1, the strategy could be used for the actuator of the wear adjuster 11 of bringing the pressing device 10 to a position of the commencing contact between friction lining and friction surface to initiate the braking, that is to say completely overcoming the air gap, e.g. by measuring the current consumption, the position or the brake torque to be set. To release the brake, the wear adjuster 11 can be moved back into a position of hardly any residual braking effect, or an air gap can be deliberately set in order to lift the friction lining completely off the friction surface in order thereby to eliminate the losses of a minimal residual braking effect. For this purpose, the wear adjuster 11 can be moved to a defined position away from the friction contact or energized for a defined time in order to remove the friction lining from the friction surface. For a floating caliper disk brake, the wear adjuster 11 can also be used in order to lift both brake linings completely off the brake disk, such as is described in more detail in WO 2010/133463 A1.

Here, the pressing device 10 comprises a retaining part 7 against which the brake lining 6 or lining carrier 5 rests. A pressure shaft 8 is mounted with both ends in the retaining part 7. The pressure shaft 8 is in turn mounted in an actuating shaft 9 designed in the form of a hollow shaft, wherein the axial bore of the actuating shaft 9 is eccentric with respect to the axis of rotation of the actuating shaft 9. The actuating shaft 9, which is mounted in a fixed or quasi-fixed brake part, here the wear adjuster 11, is rotated by an actuating device 20 so that, depending on the direction of rotation, the pressure shaft 8 is moved towards the brake disk 4 or away therefrom by the eccentric bore (indicated by the double arrows). The lining pressing forces are therefore produced here by means of an eccentric. A journal, which is arranged eccentrically on the actuating shaft 9 and on which the retaining part is mounted and arranged, could also be used instead of the pressure shaft 8 which is mounted eccentrically in the actuating shaft 9. Likewise, the pressing device 10 could be designed in the form of a cam, which engages with the lining carrier 5 or with a retaining part 7, or in the form of a toggle lever. Common to all embodiments is the actuating device 20, which rotates an actuating part of the pressing device 10, e.g. an actuating shaft 9, a cam or a lever, to actuate the friction brake 1.

Here, an electric motor 21, which by means of a linkage 22 rotates an actuating lever 23 which is arranged on the actuating shaft 9, is provided as the actuating device 20. Any other suitable drive can, of course, also be considered as the actuating device 20, e.g. an electric motor which drives the actuating shaft 9 directly or via a gearbox. Here, the pressing device 10 has a certain, defined working range in the form of an actuating angle range of the actuating part, e.g. the actuating shaft 9. At the same time, the working range is advantageously chosen such that the transmission ratios for producing the lining pressing forces are favorable.

Here, a friction brake 1 of this kind has a non-linear travel-force characteristic which is explained in more detail with reference to FIGS. 2 and 3. FIG. 2 shows the characteristic of the actuating torque T_{A} (Curve 12) and the resulting braking torque T_{B} (Curve 11) over the actuating angle α. The actuating torque T_{A} must be applied by the actuating device 20, here the electric motor 21. Here, the actuating range extends from a starting position α_{A} to a position at full braking α_{VB}. Here, the angular positions are specified referred to a zero position which corresponds to the bottom dead center of the eccentric (FIG. 3). Here, the eccentricity E (shown greatly exaggerated in FIGS. 2 and 3) is 0.5 mm, for example, thus resulting in a theoretical maximum stroke of 1 mm for the theoretical maximum angle of rotation of −90° (position furthest from the disk) to +90° (position closest to the disk). In practice, rather less of this range is used, e.g. from −60° in the starting position α_{A} to full braking α_{VB} at e.g. +60°. Here, normal braking usually takes place between an initial actuating angle α_{A} and a final actuating angle α_{E}, e.g. 15°, at which the particular braking torque T_{B} required is achieved.

As a result of the non-linear actuating mechanism, the distance traveled with low force is initially covered quickly, and the mechanical ratio changes with increasing lining pressing force to the benefit of reducing increase in lining travel (and increase in input force). When the eccentric is rotated further towards the brake disk 4, the increase in lining travel reduces and the lining pressing force increases for the same input force (or input torque). In FIG. 2, it can be seen that, due to the non-linearity, ever larger braking torques T_{B} are easily achieved by means of the eccentric without further increase in the actuating torque T_{A}. In addition, in the forward direction of travel, self-reinforcement can also act in addition to the non-linearity, as a result of which the actuating torque T_{A} even reduces, here, for example, from an actuating angle α of approximately 20°. Self-reinforcement starts from an actuating angle α=0°, that is to say when the eccentric passes the bottom dead center. Naturally, the friction brake could also be designed such that no self-reinforcement occurs, e.g. in that the brake lining or the lining carrier rests only loosely against retaining part 7, as a result of which the friction force between friction lining and friction surface would not be transmitted to the pressing device 10.

The effect of the lining elasticity on the non-linear force-travel characteristic of the friction brake 1 is now explained with reference to FIGS. 4 and 5. The curve 40 in FIG. 4 shows the typical characteristic of the actuating torque T_{A} of an electrically driven friction brake with new and unworn brake linings over an assumed range of the actuating angle α from −60° to +60°. As a result of the incipient self-reinforcement, the actuating torque T_{A} reduces once more from a certain actuating angle α. In a similar way, the curve 50 in FIG. 5 shows the braking torque T_{B}, which reaches the maximum braking torque of approx. 3500 Nm at α_{VB} with an actuating torque T_{A} of approx. 13 Nm. The example shown relates to a friction brake with an energy-efficient, stiff brake caliper of low elasticity, as a result of which the energy for actuating the friction brake is mainly put into the unavoidable lining elasticity.

Of course, the actuating angle α does not always reach the actuating angle for full braking α_{VB}. In every braking event, the brake controller will produce a required setpoint brake torque T_{B,soll}, even for individual wheels, which is then set by the friction brake 1, e.g. by appropriate activation of the actuating device 20.

The behavior of the same brake with worn brake linings is shown by the curves 41 and 51 in FIGS. 4 and 5. Full braking, defined by a certain, specified maximum setpoint braking torque, such as 3500 Nm for example, would already occur here at an actuating angle α_{VB} of approximately 15°, for which an actuating torque T_{A} of approximately 26 Nm would have to be applied. Of course, in this case, an even higher braking torque T_{B} could be achieved by turning the actuating device 20 further, which, however, will not be demanded by the brake controller. However, the transmission ratios of the eccentric at this actuating angle α_{VB} are favorable and no significant self-reinforcement can occur. Twice the actuating torque T_{A} would be required for full braking, which is naturally unfavorable from the point of view of the electrical drive and, under certain circumstances, may not be achievable at all. The reason for this is that the stiffness of the friction brake increases due to the worn brake linings, as a result of which less actuating travel is absorbed by the elasticity of the brake, in particular of the brake linings.

In order to reduce this disadvantageous effect, it is now provided to modify the initial actuating angle α_{A} to the current state of wear of the brake linings. This is shown in FIGS. 4 and 5 by the curves 42 and 52. In the exemplary embodiment shown, the initial actuating angle α_{A} with worn brake linings is set to −18° before the commencement of the braking operation so that full braking again occurs at an actuating angle α of approx. 60° and the braking process again takes place in a favorable actuating angle range with favorable transmission ratios. At the same time, it can also be seen that the actuating torque T_{A} even becomes less overall.

The effect of the state of wear of the brake linings on the initial actuating angle α_{A} can, of course, be taken into account in a brake controller in many different ways. For example, a simple tabular relationship between wear and initial actuating angle α_{A} can be stored. In doing so, the relationship could be determined by tests or calculated or simulated. Neural networks or fuzzy logic can also be considered in order to convert a certain state of wear into an initial actuating angle α_{A}, possibly taking into account other influential factors such as, for example, ambient conditions, driving situation etc. In doing so, other influential factors can, of course, also be taken into account, such as the current temperature of the brake, as the elasticity is likewise expected to rise with increasing temperature.

The state of wear of the brake or of the brake linings can likewise be determined in many different ways. For example, the state of wear that exists could be determined from the increase in braking torque T_{A} referred to the current actuating angle α. Likewise, the state of wear could be determined from observations of the braking operations, i.e. a recording could be made of how long and how hard braking occurs in the life of the linings, which, with a knowledge of the wear behavior of the brake linings, enables conclusions to be drawn relating to the state wear. The position of the wear adjuster 11 could also be stored or measured. In the same way, as is known, the air gap can be measured or derived from other measurements.

There will also be a number of other ways of determining a state of wear of the friction brake 1 or of the brake linings and of deriving a suitable initial actuating angle α_{A} for the friction brake 1 therefrom. However, according to the invention, it is not a matter of the exact method but that the effect of wear is now taken into account in the activation of the friction brake 1 in order to ensure favorable operation of the friction brake 1.

The adjustment of the required initial actuating angle α_{A} can also be carried out in many different ways. For example, it is possible to adjust the initial actuating angle α_{A} for new brake linings to the end of the intended actuating angle range, here, for example, α_{A}=−60°. For every braking operation, and therefore for ongoing wear of the brake linings, the actuating part of the actuating device 20 is no longer fully reset but rather only to the new initial actuating angle α_{A} which is dependent on the current wear. In doing so, the wear adjuster 11 ensures that the air gap is correct. The initial actuating angle α_{A} is therefore correctly set for the next braking operation and the initial actuating angle α_{A} therefore tracks the wear. In doing so, a required air gap, which can be assumed to be known, can of course also be taken into account when the air gap is overcome by the pressing device 10.

When the friction brake 1 is operated with an air gap (instead of lightly applied brake linings 3, 6), the air gap can either be overcome by means of the wear adjuster 11 before the commencement of the braking operation, e.g. in that the wear adjuster 11 guides the brake lining 3, 6 against the brake disk 4, or the pressing device 10 executes a sufficiently large stroke that the air gap is overcome first before the commencement of the braking operation.

Alternatively, it could also be provided that the air gap between brake lining and friction surface is adjusted by the wear adjuster 11 as a function of the current wear to a value such that this results in the required initial actuating angle α_{A} when the brake is actuated. For this purpose, the brake can always be operated in the intended actuating angle range, e.g. α_{A}=−60° up to the final angle determined by the wear. In addition, the necessary air gap can be set after each braking operation such that the initial actuating angle α_{A} is already set up for the next braking operation. Alternatively, the air gap, and therefore the initial operating angle α_{A}, is adjusted accordingly before each braking operation.

An electrically actuated, non-linear friction brake 1 is not actuated directly but indirectly via a brake controller 63 (see FIG. 6). Here, a brake pedal position can be evaluated by the brake controller and converted into a control command for the friction brake 1, or for the pressing device 10, and, if necessary, for the wear adjuster 11. At the same time, the brake controller ensures a correct and pleasant pedal feel. If required, the pedal feel is to become firmer with increasing braking. The pedal travel can also be adjusted by means of the brake controller, as the pedal travel becomes longer with increased wear of the brake linings. When the linings are replaced, the pedal feel would even change suddenly in that the hard pedal feel with worn brakes would revert to a softer pedal feel which could possibly irritate the driver during severe braking operations or give him the feeling of a defective brake. The object is therefore to keep the pedal feel as constant as possible so that the driver does not at all perceive or hardly perceives the state of wear of the brake linings at the brake pedal.

At the same time, the effect of wear on the pedal feel could in turn be compensated for as a function of the current state of wear by means of tables, neural networks, fuzzy logic etc.

In the same way, the change in the operating behavior could be compensated for if the brake linings were completely raised before the braking operation in order to overcome the air gap at the commencement of the braking operation unnoticed by the driver.

Similarly, this also enables the current operating condition of the brake to be represented by the pedal feel. When hot, the friction brake can become more elastic, e.g. due to components, such as brake linings or brake caliper for example, becoming softer. This can be compensated for as a change in elasticity in order to communicate a constant impression to the driver. However, the opposite reaction can also be expedient to give the driver a particularly soft pedal feel in the case of dangerous overheating as pre-warning of an imminent loss of braking effect due to overheating brakes. For example, with slight overheating, the changing behavior of the friction brake can be withheld from the driver (compensated) and overemphasized if the overheating becomes dangerous in order to initiate the warning to the driver.

When the brake linings are completely worn, a residual braking effect occurs between friction surface and lining carrier, e.g. between steel-steel. This condition can again be communicated to the driver as a pedal feel, e.g. by particularly long pedal travel, in order to intensively communicate a reduced braking effect.

However, this communication by means of the pedal feel can, of course, be used for any conditions, e.g. an overweight trailer, which is artificially communicated by means of the pedal feel, or other conditions arising from road or vehicle.

As is known, the pedal feel can be produced passively or actively. Passively, e.g. with the known combinations of springs and elastomers (“rubber”) with which the characteristic that the pedal should become disproportionately increasingly hard with more severe braking (disproportionately increasing force application) is reproduced. Wherein, of course, this effect can also be produced in different ways, e.g. by lever action, a plurality of springs, progressive springs, etc. The pedal force can be produced or varied actively, e.g. with controlled actuators such as electric motor(s) for example. The familiar “ABS vibration” at the pedal could also be artificially induced or other feedbacks reproduced by the braking force. The active method naturally offers more possibilities of influencing the pedal feel by feeding in forces, but is more cost intensive. However, the pedal feel can also be varied with the passive pedal. The chosen spring effect (e.g. spring-elastomer combination) results in a force-travel characteristic of the pedal. If it is now required to communicate a harder pedal feel, the electronic evaluation of the pedal, for example, can be varied (e.g. by the brake controller) such that a certain braking effect does not occur until the pedal is pressed further (more pedal force). Conversely, a softer (lighter)-to-operate brake can be achieved for a specified spring effect in that the electronic evaluation of the pedal already brings about the required braking effect when the pedal is not pressed so hard (less pedal force). This adjustment of the evaluation can, of course, also be used additionally with an active pedal. Also, the pedal force does not necessarily have to increase disproportionately with harder braking; only good modulation and familiar operation by the driver are important.

The electrically actuated friction brake can also be actuated from other sources instead of by the driver, e.g. from driver assist systems such as emergency braking in the event of an anticipated detection of an accident, gap maintenance, a cruise control system, “convoy driving” (electronically “coupled” vehicle train which is not mechanically connected but which maintains the distance by electronic control), etc. The mixture of regenerative braking via the generator of an electric or hybrid vehicle and friction braking can also produce an input variable to the brake controller.

For this purpose, it can be expedient to transmit data relating to the vehicle, driving and/or brake condition to the brake controller via suitable interfaces. In this way, the brake controller can respond to a setpoint braking torque, e.g. from the brake pedal, from a driver assist system, etc., with an actual braking torque which is as accurate as possible, wherein, if necessary, also the internal states of the brake, such as state of wear of the brake lining, brake temperature, etc., are taken into account in order to match the actual value to the setpoint as well as possible.

A vehicle 60 with two friction brakes 1a, 1b on the front wheels 61, 62 is shown by way of example in FIG. 6. The friction brakes 1a, 1b are activated by a brake controller 63 depending on the situation. In doing so, the brake controller 63 can provide a setpoint braking torque T_{B,soll} or setpoint actuating torque T_{A,soll} which is to be set by the friction brake 1a, 1b. For this purpose, the actuating device 20a, 20b of the friction brake 1a, 1b can be activated by means of suitable control signals in order to produce an appropriate actuating torque T_{A}. This can, of course, also be carried out in a closed control loop, for which either the actual braking torque T_{B,ist} or the actual actuating torque T_{A,ist} can be measured. As it has long been known per se how a setpoint braking torque T_{B,soll} of a friction brake can be determined, this is not discussed in more detail here. At the same time, the brake controller 63 measures the state of wear of the brake linings of the friction brake 1a, 1b, e.g. by measuring the actual actuating torque T_{A,ist} and the current actuating angle α. Based on the state of wear, the brake controller 63 also determines an initial actuating angle α_{A} matched to the state of wear, which can likewise be set by the actuating device 20a, 20b before the commencement of the braking operation. For this purpose, the brake controller 63 could, of course, also receive and process the signals of further sensors 64, such as, for example, temperature sensors, acceleration sensors, tire slip sensors, etc.

A braking operation can be initiated by a driving or braking assist system 66 of the vehicle, such as, for example, ABS, ESG, cruise control, etc.

The brake controller 63 can also set an appropriate pedal feel in order to communicate to the driver the correct brake feel at the brake pedal 65.

The brake controller 63 can, of course, also control the function of a wear adjuster 11 which may be provided, e.g. in that an air gap, which may be present between brake lining and friction surface, is first overcome before a braking operation.

1. A method for operating an electrically actuated friction brake (1) with non-linear force-travel characteristic, wherein, in order to brake, an actuating part of a pressing device (10) arranged on a wear adjuster (11) is rotated by means of an actuating device (20) between an initial actuating angle (α_{A}) and a final actuating angle (α_{E}) in order to press a brake lining (6) against a friction surface to produce a braking torque (T_{B}), characterized in that the initial actuating angle (α_{A}) of the actuating part is adjusted as a function of a current state of wear of the brake lining (6) in order to compensate for the changing force-travel characteristic of the friction brake (1) as the brake lining (6) wears.

2. The method as claimed in claim 1, characterized in that a brake pedal feel is adjusted as a function of the current state of wear of the brake lining (6).

3. The method as claimed in claim 1, characterized in that an air gap between brake lining (6) and friction surface is overcome by a wear adjuster (11) before the braking operation.

4. A braking system with an electrically actuated friction brake (1) with non-linear force-travel characteristic and a brake controller (63) for activating the friction brake (1), wherein the friction brake (1) has an actuating device (20) which rotates an actuating part of a pressing device (10) between an initial actuating angle (α_{A}) and a final actuating angle (α_{E}) in order to press a brake lining (6) against a friction surface to produce a braking torque (T_{B}), wherein the pressing device (10) is arranged on a wear adjuster (11), characterized in that the brake controller (63) adjusts the initial actuating angle (α_{A}) of the actuating part as a function of a current state of wear of the brake lining (6) in order to compensate for the changing force-travel characteristic of the friction brake (1) as the brake lining wears.

5. The braking system as claimed in claim 4, characterized in that a brake pedal (65) is provided and the brake controller (63) adjusts a brake pedal feel as a function of the current state of wear of the brake lining (6).

6. The braking system as claimed in claim 4, characterized in that the wear adjuster (11) is provided to overcome an air gap between brake lining (6) and friction surface before the braking operation.
